(19) United States
(12) Patent Application Publication
(10) Pub. No.: US 2010/0077026 A1
(43) Pub. Date: Mar. 25, 2010

(54) METHOD OF REGISTERING ACCESS PERMISSION AND A SERVER APPARATUS

(76) Inventors: Shigeaki Watanabe, Kyoto (JP); Yousuke Suzuki, Osaka (JP); Naoya Takao, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/542,169

(22) Filed: Aug. 17, 2009

(30) Foreign Application Priority Data
Aug. 18, 2008 (JP) 2008-209834

(51) Int. Cl. G06F 21/00; G06F 15/16

(52) U.S. Cl. 709/203; 726/4

(57) ABSTRACT

A method of registering access permission from a client apparatus into a server apparatus connected to one network, includes: notifying device information about the server apparatus to the client apparatus connected to the same network; starting reception of a registration request for access permission from the client apparatus to the server apparatus; counting a certain period starting from a point in time at which the reception of the registration request for access permission is started; determining whether the server apparatus which receives the registration request for access permission is selected from the client apparatus and the registration request for the access permission of the access to the selected server apparatus is received within the certain period; and registering the access permission for the client apparatus requesting for the registration of access permission into the server apparatus, when the registration request for access permission is received within the certain period.

### BACKGROUND OF THE INVENTION

The present application claims the priority of Japanese Patent Application No. 2008-209834 filed on Aug. 18, 2008 in Japan, and the contents of which are incorporated herein by reference.

1. Field of the Invention

The present invention relates to a method of registering access permission for registering a client device in a server device and setting permission of access from the client device to the server device in a home network system, as well as to a server apparatus and a client apparatus.

2. Description of the Related Art

Recently, technologies such as computers and networks are penetrating deeply into general homes. At home, various home information appliances, such as television receivers and video reproducing apparatuses, and personal computers are mutually connected to each other via home networks. Such home networks are mutually connected to external wide-area networks including the Internet via routers in many cases. After contents properly acquired from servers on the Internet are accumulated at server devices on the home networks (hereinafter also referred to as “home servers”), they are delivered to other terminals at home (client devices) via the home networks. When broadcast programs to be viewed are recorded at home, the recorded programs are delivered to the other terminals at home via the home network.

Since contents such as private contents and charged contents which require copyright management are stored in a device such as a home server in the home network, a countermeasure against unauthorized accesses should be considered. Similarly as to broadcast, when a charged broadcast and a copy-protected broadcast are recorded, the countermeasure against unauthorized accesses should be considered.

Accesses by user's devices having licenses of contents should be permitted. However, in an environment of a home network mutually connected to an external network via a home router, a user who does not have the license might enter the home network from the external network.

In order to eliminate unauthorized accesses, a list of client devices permitted to access to a home server is maintained in the home server, and every time the client devices request the home server to access thereto, a matching process with the list is executed, so that the unauthorized accesses can be eliminated.

For example, MAC (Media Access Control) address filtering, which creates an access permitted device list using MAC addresses as physical addresses specific to each communication device, is known. In the MAC address filtering, originally MAC addresses with which accesses are permitted are registered in advance in a router or a gateway which separates an internal network (subnet) such as a home network from an external network, and a MAC address of a received packet is matched with the registered MAC addresses, so that an access from a device having an unregistered MAC address is denied. A function equivalent to this is mounted to a home server, and an access from a specific client device is denied or permitted, so that the unauthorized accesses can be eliminated. Such a kind of technique is disclosed in, for example, Japanese Patent Laid-Open Publication No. 10-271154.

### SUMMARY OF THE INVENTION

However, in the conventional technique, in order to register MAC addresses (row of numbers) with which accesses are permitted, the MAC addresses of the devices to be permitted for access should be searched and obtained in advance. However, it is not generally easy to see a list of the rows of numbers and determine MAC addresses of desired devices. Since the MAC addresses have a comparatively large number of digits, it is not easy to memorize them. Therefore, it is not realistic for general users to check MAC addresses in such a manner.

In a home network, a process of adding new devices is executed every time a network compatible device is purchased. If a user keeps checking MAC addresses of devices and registering them at the time of such a device adding process, easiness of network construction is inhibited.

On the other hand, a communicable device easily intrudes a wireless LAN from the outside due to the spread of wireless LANs. In such a network environment, unauthorized accesses to network connected devices easily occur, and thus the likelihood that, e.g., secret information is stolen by unauthorized accesses and contents are illegally read is increased. In such a condition, it is required that a suitable access control structure is easily constructed without placing a burden on general users.

The present invention was made in order to solve the conventional problem, and an object of the invention is to provide a method of registering access permission with which a user can register access permission for a client device easily and accurately and can eliminate unauthorized use of contents stored in a server device, as well as to a server apparatus and a client apparatus.

A method of registering access permission from a client apparatus into a server apparatus connected to one network, includes the steps of: notifying device information about the server apparatus to the client apparatus connected to the same network; starting reception of a registration request for access permission from the client apparatus to the server apparatus; counting a certain period starting from a point in time at which the reception of the registration request for access permission is started; determining whether the server apparatus which receives the registration request for access permission is selected from the client apparatus and the registration request for the access permission of the access to the selected server apparatus is received within the certain period; and when the registration request for access permission is received within the certain period, registering the access permission for the client apparatus requesting for the registration of access permission into the server apparatus.

The method may further include: a step of determining whether the server apparatus acquires an IP address in the network; and a prompting display step of, when the server apparatus acquires the IP address in the network, displaying a screen for prompting start of the reception of the registration request for access permission from the client apparatus to the server apparatus on a screen of the server apparatus.

The method may further include: a step of identifying that the client apparatus is connected to the same network as the server apparatus; and a prompting display step of, when it is identified that the client apparatus is connected to the same network, displaying a screen for prompting the start of the reception of the registration request for access permission from the client apparatus to the server apparatus on a screen of the server apparatus.

At the step of determining whether the IP address is acquired, determination may be made whether the server apparatus acquires the IP address by polling, and the polling may be stopped upon execution of the prompting display step.

At the step of identifying that the client apparatus is connected to the same network as the server network, determination may be made whether the server apparatus recognizes the client apparatus by polling, and the polling may be stopped upon execution of the prompting display step.

The method may further include the step of: when the registration request is received after the certain period elapses, transmitting, to the client apparatus, information for informing the client apparatus which requests the registration that the client network is unregistered and the registration of permission to access to the server apparatus is required.

A server apparatus which registers access permission from a client apparatus to the server apparatus connected to one network, includes: a device information storage unit which notifies device information about the server apparatus to the client apparatus connected to the same network; a counting unit which counts a certain period starting from a point in time at which reception of a registration request for access permission is started; a reception determining unit which determines whether the server apparatus is selected by the client apparatus and the registration request for access permission from the client apparatus to the server apparatus is received; and an access permission registering unit which, when the registration request for access permission is received within the certain period, registers access permission for the client apparatus which requests the registration of access permission to access to the server apparatus.

The server apparatus may further include: an IP address acquisition determining unit which determines whether the server apparatus acquires an IP address; and a display unit which, when the server apparatus acquires the IP address, displays a screen for prompting the registration request for the permission to access to the server apparatus on a display screen of the server apparatus.

The server apparatus may further include: a client determining unit which determines whether the client apparatus is connected to the same network as the server apparatus; and a display unit which, when the identification is made that the client apparatus is connected to the same network, displays a screen for prompting start of the reception of the registration request for the permission to access to the server apparatus from the client apparatus on a display screen of the server apparatus.

The IP address acquisition determining unit may determine whether the server apparatus acquires the IP address by polling, and may stop the polling upon registration of access permission for the client apparatus in the access permission registering unit.

The client determining unit may determine whether the client apparatus is recognized by polling, and may stop the polling upon registration of the access permission for the client apparatus in the access permission registering unit.

The access permission registering unit may further determine whether a code preset by the client apparatus is received, and may register the access permission for the client device only when the preset code is received.

A client apparatus which requests registration of permission to access to a server apparatus from the client apparatus connected to one network, includes: a device recognizing unit which receives notification of device information about the server apparatus from the server apparatus connected to the same network; and an access permission registration requesting unit which selects the server apparatus and requests registration of the permission to access to the server apparatus.

A server apparatus which registers permission to access to the server apparatus from a client apparatus connected to one network, includes: a device information storage unit which notifies device information about the server apparatus to the client apparatus connected to the same network; a reception determining unit which, when the server apparatus is selected from the client apparatus and a request for the permission to access to the server apparatus is received from the client apparatus, compares a device identification ID of the client apparatus transmitting the registration request for access permission with a stored device identification ID list, and when the client apparatus is a new client device having a device identification ID not described in the device identification ID list, receives determination whether the access permission for the client apparatus is registered; and an access permission registering unit which, when the determination of the access permission is received, registers the permission for the client apparatus to access to the server apparatus.

A method of permitting server access (A method of registering access permission) from a client apparatus to a server apparatus connected to one network, includes the steps of: notifying device information about the server apparatus to the client apparatus connected to the same network from a server apparatus side; when the server apparatus is selected from the client apparatus and a registration request for permission to access to the server apparatus from the client apparatus is received, comparing a device identification ID of the client apparatus transmitting the registration request for access permission with a stored device identification ID list; when the client apparatus is a new client device having a device identification ID not described in the device identification ID list, receiving determination whether the registration of the access permission for the client device is registered; and when the determination of the access permission is received, registering the permission for the client apparatus to access to the server apparatus.

With the method of registering access permission, the server apparatus, and the client apparatus of the present invention, a user can register permission for a client device to access to a server device easily and accurately. Further, data in the server device can be protected against external devices.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a schematic diagram illustrating one example of a constitution of a home network system according to the first embodiment;

FIG. 2 is a block diagram illustrating constitutions of a server device and a client device according to the first embodiment;

FIG. 3 is a schematic diagram illustrating functions of the server device and the client device shown in FIG. 2;

FIG. 4 is a screen transition diagram illustrating initial setting of access permission registration on the server device according to the first embodiment;

FIG. 5 is a schematic diagram illustrating screen transition of initial setting of access permission registration from a menu screen of the server device according to the first embodiment;

FIG. 6 is a diagram illustrating one example of an unregistered message;

FIG. 7 is a flowchart illustrating a method of registering access permission according to the first embodiment;

FIG. 8 is a flowchart illustrating another exemplary method of registering access permission according to the first embodiment;

FIG. 9 is a screen transition diagram illustrating the access permission registration according to the second embodiment; and

FIG. 10 is a flowchart illustrating the method of registering access permission according to the second embodiment.

### DETAILED DESCRIPTION OF THE PREFERRED EMBODIMENTS

Methods of registering access permission according to embodiments are specifically described below with reference to the drawings.

### First Embodiment

In the method of registering access permission according to the first embodiment, in a home network system where a server device and a client device are connected, the server device starts reception of a registration request for access permission from the client device. The client device selects the server device which receives the registration request for access permission and transmits an acquisition request for a remote UI (User Interface) application. The acquisition request for the remote UI application corresponds to the registration request for permission of access from the client device to the server device. When the server device receives the acquisition request for the remote UI application from the client device within a certain period after the start of the reception, access permission is registered of the client device.

Constitutions in the method of registering access permission are described below.

### [Constitution of Home Network System]

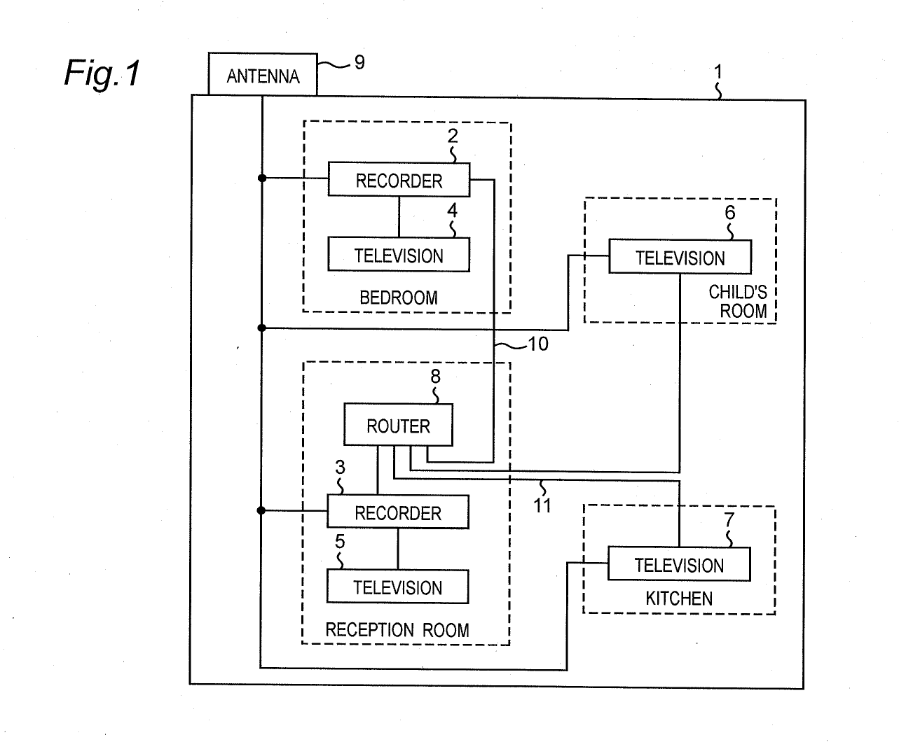

FIG. 1 illustrates one example of a constitution of the home network system according to the first embodiment. In FIG. 1, the home network system 1 has two recorders 2 and 3, four televisions 4, 5, 6, and 7 and one router 8. The recorder 2 and the television 4 are installed in a bedroom, the recorder 3, the television 5, and the router 8 are installed in a reception room, the television 6 is installed in a child's room, and the television 7 is installed in a kitchen. The recorder 2 is video-connected to the television 4, and the recorder 3 is video-connected to the television 5. A broadcast signal received by an antenna 9 is inputted into the recorders 2 and 3, and the televisions 6 and 7. The recorders 2 and 3, and the televisions 6 and 7 are connected to the router 8 into a star shape. The recorders 2 and 3 are server devices, and the televisions 6 and 7 are client devices. The televisions 4 and 5 which are video-connected to the server devices 2 and 3, respectively, serve also as display units of the server devices 2 and 3.

### [Constitutions of the Server Device and the Client Device]

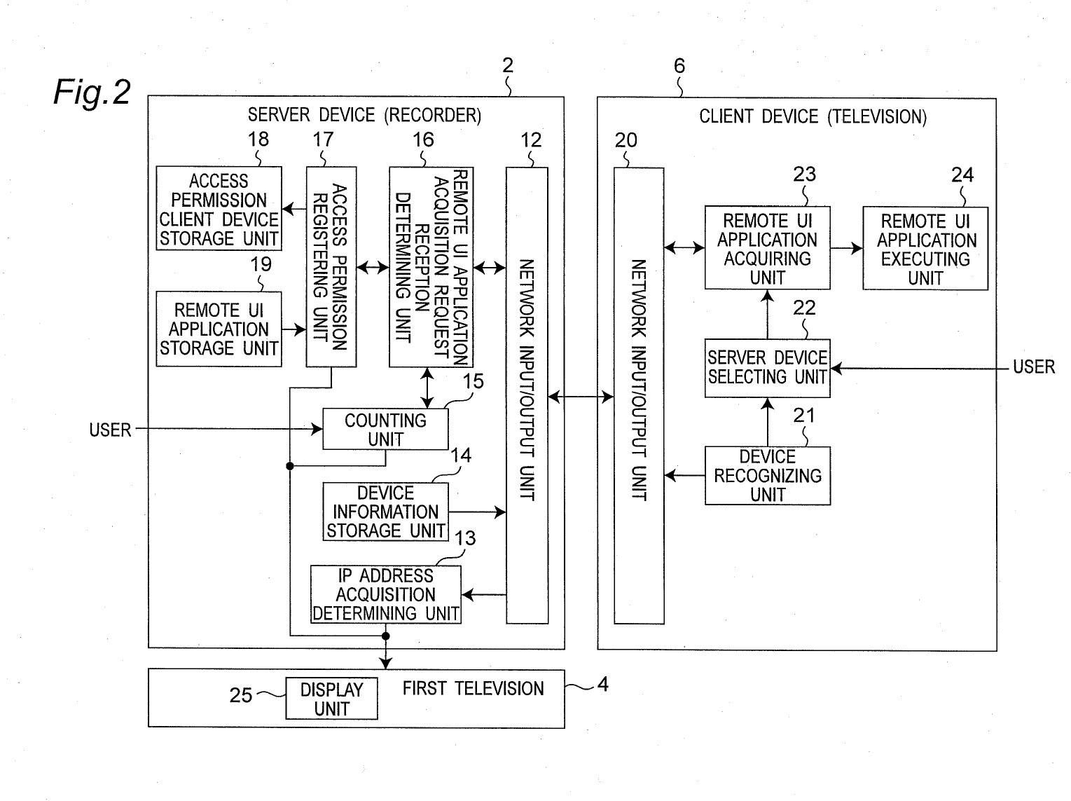

FIG. 2 illustrates constitutions of the server device 2 and the client device 6 according to the embodiment. FIG.1 illustrates the two recorders 2 and 3 and the four televisions 4, 5, 6, and 7, but FIG. 2 illustrates the recorder 2 (server device), the television 4, and the television 6 (client device) for convenience of the description.

### [The Server Device]

The server device 2 has a network input/output unit 12, an IP address acquisition determining unit 13, a device information storage unit 14, a counting unit 15, a remote UI application acquisition request reception determining unit 16, an access permission registering unit 17, an access permission client device storage unit 18, and a remote UI application storage unit 19.

The network input/output unit 12 inputs/outputs data via a network.

The IP address acquisition determining unit 13 performs polling at, for example, one-minute intervals so as to determine whether the server device 2 acquires a self IP address. For example, when a recorder 2 is newly purchased and a LAN cable 10 is inserted into the recorder 2 in FIG. 1, the IP address acquisition determining unit 13 acquires the IP address of the server device 2 from the router 8. When the IP address acquisition determining unit 13 acquires the IP address, it may instruct a display unit 25 of the television 4 to display a screen for prompting start of the reception of registration of access permission for the client device.

The device information storage unit 14 stores device information about the server device 2 in advance. When the client device 6 inquires of the device information about the server device 2, the device information about the server device 2 is read from the device information storage unit 14, and the read information is transmitted to the client device 6. A standard specification such as UPnP (Universal Plug and Play) can be used for the transmission of the device information.

The counting unit 15 starts the reception of the request made by the user for registration of permission of access from the client device to the server device. The counting unit 15 performs counting for a certain period starting from the time at which the reception of the request for the registration of the access permission is started. When the countdown for the certain period is ended, the display unit 25 of the television 4 video-connected thereto may be instructed so that the screen for prompting start of the reception of the request for the registration of the access permission from the client device is deleted on the display screen of the server device 2.

The remote UI application acquisition request reception determining unit 16 determines whether an acquisition request of the remote UI application is received from the client device within a certain period for which the counting unit 15 performs the counting. The acquisition request for the remote UI application simultaneously corresponds to the registration request for the access permission. When the remote UI application acquisition request reception determining unit 16 receives the acquisition request for the remote UI application for the certain period for which the counting unit 15 performs the counting, the unit 16 determines that the client device 6 which receives the request as a client device which can be permitted for access.

The access permission registering unit 17 registers the access permission for the client device, which is determined as the client device which can be permitted to access. When the access permission registering unit 17 receives the request within the certain period for which the counting unit 15 performs the counting, the access permission registering unit 17 checks a specific communication text such as a predetermined plug or cord in an option space of UPnP (Universal Plug and Play), so as to determine whether the client device 6 is an authorized device, and may determine the authorized client device 6 as the access permitted client device.

The access permission client device storage unit 18 stores access permission client devices. The access permission registering unit 17 registers the access permitted client devices into the access permission client device storage unit 18 (register access permission).

The remote UI application storage unit 19 stores an encrypted remote UI application in advance. After the access permission registration, the access permission registering unit 17 reads the encryption remote UI application from the remote UI application storage unit 19, and transmits the read encryption remote UI application to the client device 6 (send a reply to the acquisition request).

A hardware configuration of the control system of the server device 2 may include a storage device such as a CPU, a RAM, a ROM, or a hard disk, an input/output unit, and the like similarly to normal computers. In this case, the network input/output unit 12, the IP address acquisition determining unit 13, the device information storage unit 14, the counting unit 15, the remote UI application acquisition request reception determining unit 16, the access permission registering unit 17, the access permission client device storage unit 18, the remote UI application storage unit 19, and the like may form a physical constitution or a functional constitution. The above components may be implemented by software on a computer.

### [Client Device]

The client device 6 has a network input/output unit 20, a device recognizing unit 21, a server device selecting unit 22, a remote UI application acquiring unit 23, and a remote UI application executing unit 24.

The network input/output unit 20 inputs and outputs data via the network.

When the client device 6 is powered on, the device recognizing unit 21 inquires at the device connected to the same network of information about that device. The list of the devices on the network and the device information are sent to the server device selecting unit 22.

The server device selecting unit 22 gives a user the list of the devices and the device information collected by the device recognizing unit 21, and allows the user to select the server device 2 of which access permission is registered from the list, in which way the server device selecting unit 22 receive the user's selection.

The remote UI application acquiring unit 23 transmits a request for acquisition of a remote UI application to the server device (the server device 2 as one example) selected by the server device selecting unit 22, and acquires an encryption remote UI application from the server device 2. The request for the acquisition of the remote UI application corresponds to the registration request for the access permission.

The remote UI application executing unit 24 uses a key owned only by the authorized client device 6 so as to decode (decipher) the acquired encryption remote UI application. The decipher key is held in a predetermined storage unit (not shown) in the client device 6. The remote UI application executing unit 24 displays or reproduces data of the server device 2 using the decoded remote UI application. The remote UI application is described as script, and does not depend on the type of a CPU of the client device.

The hardware configuration of the control system of the client device 6 may only include a storage device such as a CPU, a RAM, a ROM, or a hard disk, an input/output unit, and the like similarly to normal computers. In this case, the device recognizing unit 21, the server device selecting unit 22, the remote UI application acquiring unit 23, the remote UI application executing unit 24, and the like may form a physical constitution or a functional constitution. Further, the components may be implemented by software on a computer.

### [Operations of the Server Device and the Client Device]

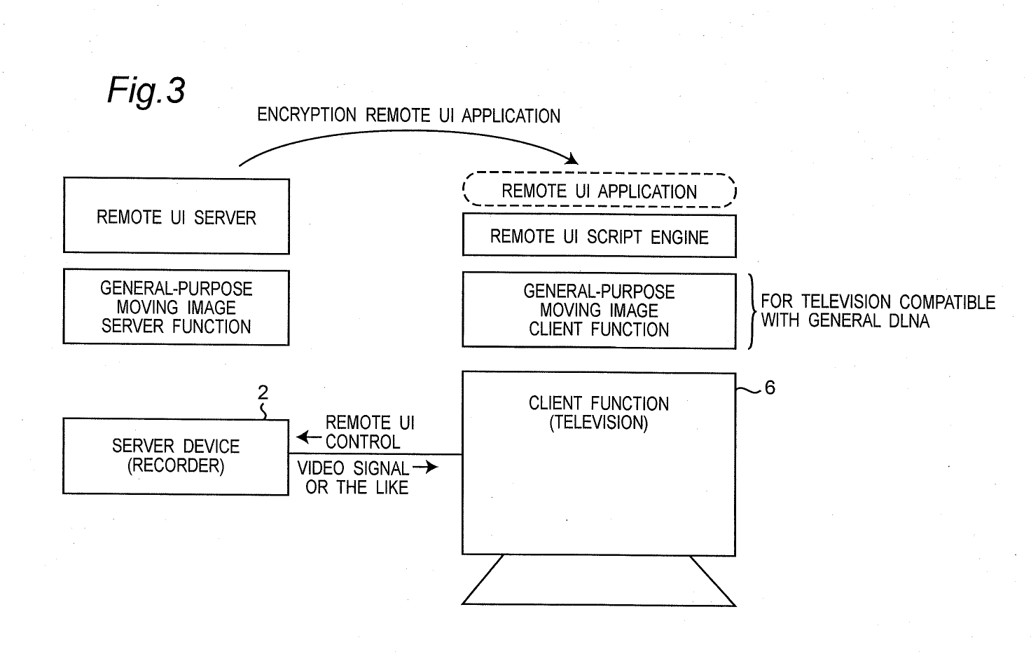

FIG. 3 illustrates operations of the server device 2 and the client device 6 of FIG. 2. The server device 2 has a general-purpose moving image server function complying with the DLNA (Digital Living Network Alliance) standard, and a remote UI server. The client device 6 has a general-purpose moving image client function complying with the DLNA standard and a remote UI script engine at the time of shipment of the product. After the access permission registration, the client device 6 acquires the encryption remote UI application from the remote UI server, and decodes the acquired encryption remote UI application into the remote UI application by using the decipher key. The remote UI application is an application for GUI display, and the remote UI script engine is an application for controlling hard disk or the like. As a result, when the recorder 2 is renewed, the television 6 can acquire a new remote UI application, and thus even if the television 6 is not renewed, the user can use a new function on the television 6.

### [Initial Setting Method]

At first, there is described a method of registering access permission so that after the renewed recorder 2 is connected to the home network of FIG. 1 (the LAN cable 10 is inserted into the recorder 2), the television 6 (client device) can immediately use the recorder 2 (server device).

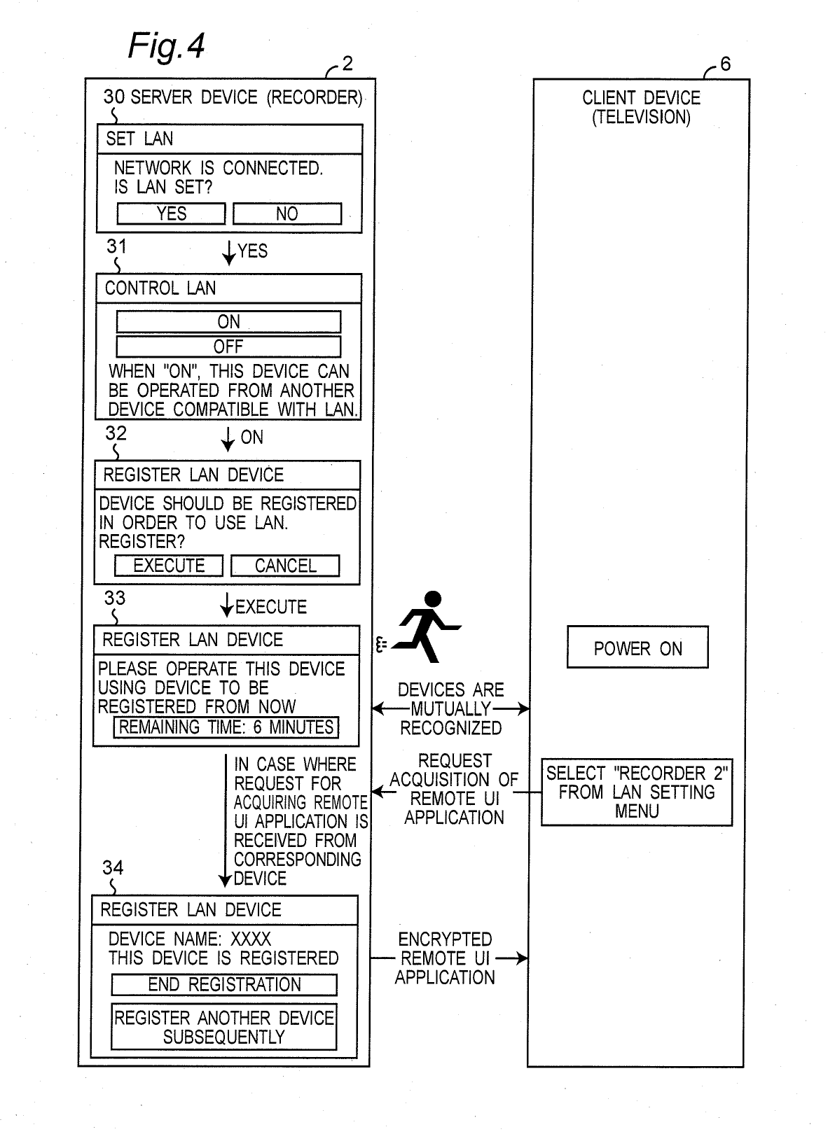

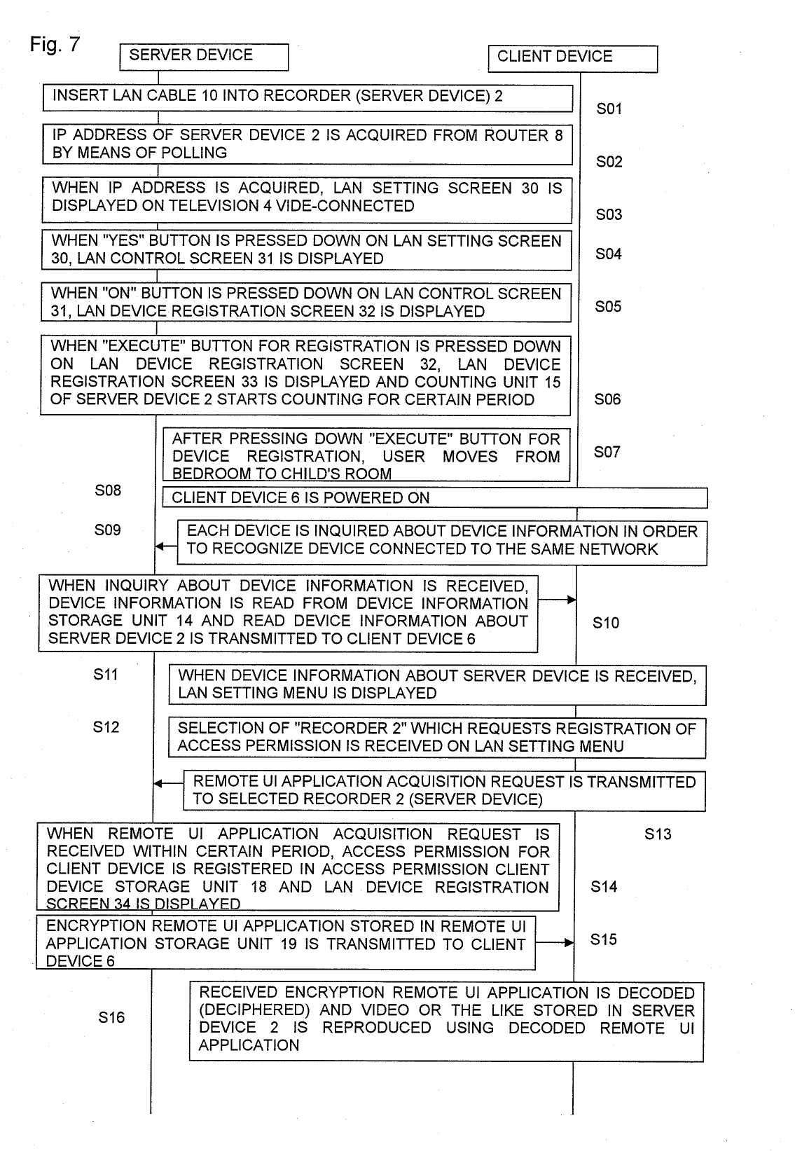

FIG. 4 illustrates screen transition of the initial setting of the access permission registration of the server device according to the first embodiment. FIG. 7 illustrates a flowchart of the method of registering access permission according to the first embodiment.

(a) The LAN cable 10 is inserted into the recorder (server device) 2 (S01). When the LAN cable 10 is inserted into the recorder (server device) 2, the IP address acquisition determining unit 13 of the server device 2 acquires an IP address of the server device 2 from the router 8 by means of polling (S02).

(b) When the IP address acquisition determining unit 13 acquires the IP address, the IP address acquisition determining unit 13 displays a LAN setting screen 30 on the television 4 video-connected to the server device 2 (S03). At this time, the polling may be stopped.

(c) When a “Yes” button is pressed down on the LAN setting screen 30, a LAN control screen 31 is displayed (S04).

(d) When an “On” button is pressed down on the LAN control screen 31, a LAN device registration screen 32 is displayed (S05).

(e) When an “Execute” button for device registration is pressed down on the LAN device registration screen 32, a LAN device registration screen 33 is displayed, and counting for a certain period is started at the counting unit 15 of the server device 2 (S06). The certain period is 10 minutes. The certain time may be suitably set within a range necessary for a user's movement to be described later.

(f) As shown in FIG. 1, since the recorder (server device) 2 is in the bedroom and the television (client device) 6 is in the child's room, the user presses down the “Execute” button for device registration on the server device 2, and moves from the bedroom to the child's room (S07). This movement should be completed within the above certain time.

(g) The client device 6 is powered on (S08). When the client device 6 is powered on, the device recognizing unit 21 of the client device 6 inquires at each device of device information in order to recognize devices connected to the same network (S09).

(h) When the server 2 receives the inquiry about the device information, it reads the device information from the device information storage unit 14, and transmits the read device information about the server device 2 to the client device 6 (S10).

(i) When the client device 6 receives the device information about the server device 2, the client device 6 displays the LAN setting menu (S11).

(j) The client device 6 receives selection of “the recorder 2”, which requests registration of access permission on the LAN setting menu, on the display screen of the client device 6 (S12). The remote UI application acquiring unit 23 of the client device 6 transmits the acquisition request for the remote UI application to the selected recorder 2 (server device) (S13).

(k) When the remote UI application acquisition request reception determining unit 16 of the server device 2 receives the acquisition request for the remote UI application within a certain period, the access permission registering unit 17 registers access permission for the client device requesting the acquisition of the remote UI application into access-permitted client device storage unit 18, and allows a LAN device registration screen 34 to be displayed (S14).

(I) Further, the access permission registering unit 17 of the server device 2 transmits the encryption remote UI application stored in the remote UI application storage unit 19 to the client device 6 (S15).

(m) The client device 6 decodes (deciphers) the received encryption remote UI application, and reproduces a video or the like stored in the server device 2 by using the decoded remote UI application (S16).

The first embodiment describes the initial setting in wired connection that the LAN cable 10 is inserted into the recorder 2, but the initial setting method is not limited to this. For example in a case of a wireless LAN, the initial setting is carried out over wireless connection. Although a route is different between wired connection and wireless connection, also when the IP address of the server device 2 is acquired from the router 8 wirelessly connected to the server device 2, the initial setting is similar to the above.

In the first embodiment, when the server device 2 (IP address acquisition determining unit 13) acquires the IP address of the server device 2 from the router 8 by means of polling, the LAN setting screen 30 is displayed in order to prompt the television 4 to start receiving the registration request of access permission. Instead of this, when the server device 2 recognizes the client device 6 by means of the polling, the LAN setting screen 30 may be displayed on the television 4. At this time, the polling may be stopped. As a result, after the determination is made whether the client device 6 has the display unit, the initial setting of the present invention can be performed.

In the first embodiment, when the server device 2 receives the acquisition request for the remote UI application within a certain period, the server device 2 registers the access permission for the client device which transmits the acquisition request for the remote UI application, and transmits the encryption remote UI application to the client device. Instead of this, when the server device 2 receives the acquisition request for the remote UI application within the certain period, the server device 2 may only register access permission for the client device. In this case, when the acquisition request for the remote UI application is received again, determination is made whether the client device has been registered, and when the client device has been registered, the encryption remote UI application may be transmitted to the client device.

In the first embodiment, the LAN setting screen 30 or the like is displayed on the television 4 video-connected to the server device 2 as the display screen of the server device 2, but the display is not limited to this, and the LAN setting screen 30 may be displayed on the display unit of the very server device 2.

[Method of Registering a Device after the Initial Setting]

Described below is a method of registering access permission so that the television 6 (client device) can use the recorder 2 (server device) on a menu screen of the server device 2 without registering access permission immediately after the recorder (server device) 2 is connected.

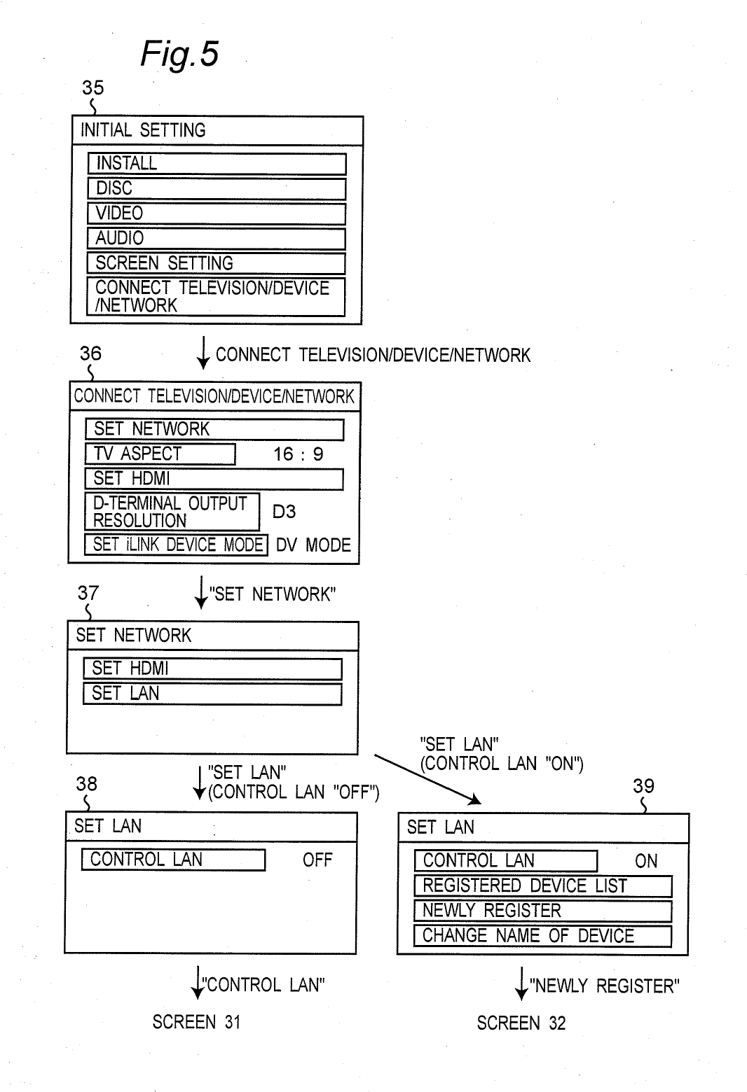

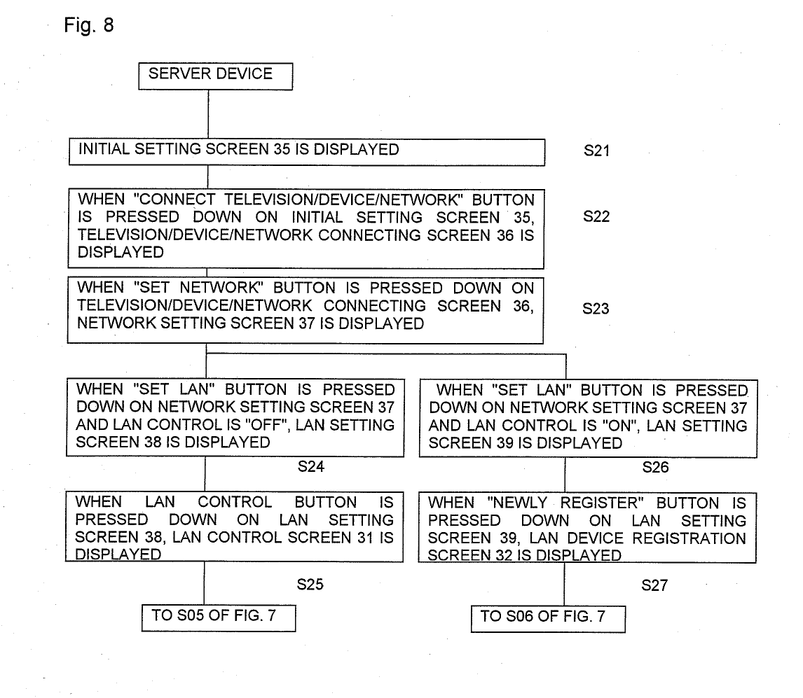

FIG. 5 illustrates screen transition of the initial setting of the registration of access permission from the menu screen of the server device according to the first embodiment. Further, FIG. 8 illustrates a flowchart of another exemplary method of registering access permission according to the first embodiment.

(a) An initial setting screen 35 is displayed on the television 4 video-connected to the server device 2 by a user's instruction (S21).

(b) When a “connect television/device/network” button is pressed down on the initial setting screen 35 of the server device 2, a television/device/network connecting screen 36 is displayed (S22).

(c) When a “set network” button is pressed down on the television/device/network connecting screen 36 of the server device 2, a network setting screen 37 is displayed (S23).

(d-1) When a “set LAN” button is pressed down on the network setting screen 37 of the server device 2, a LAN setting screen 38 is displayed in a state where the LAN control is “off” (S24).

(e-1) When a LAN control button is pressed down on the LAN setting screen 38, the LAN control screen 31 (see FIG. 4) is displayed (S25).

(d-2) On the other hand, the “set LAN” button is pressed down on the network setting screen 37, a LAN setting screen 39 is displayed in a state where the LAN control is “on” (S26).

(e-2) When a “newly register” button is pressed down on the LAN setting screen 39, the LAN device registration screen 32 (see FIG. 4) is displayed (S27).

Hereinafter, the screen transition is performed similarly to FIG. 4.

Described is a case where the acquisition request for the remote UI application is received after the certain period for which the counting unit 15 performs counting passes in the remote UI application acquisition request reception determining unit 16 of the server device 2. When the acquisition request for the remote UI application is received after the certain period for which the counting unit 15 performs the counting passes, the client device (for example, the television 7) which transmits the acquisition request for the remote UI application is determined as a client device of which access is not permitted. In this case, an unregistered message display application may be transmitted to that client device 7. The unregistered message display application is stored in the remote UI application storage unit 19 in advance similarly to the encryption remote UI application, and is described by script.

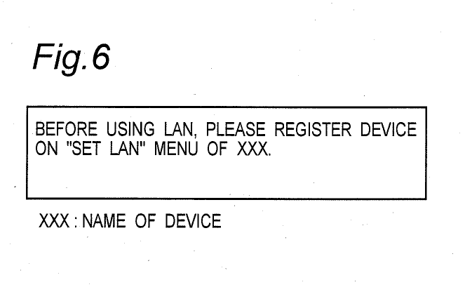

The client device 7 executes the received unregistered message display application. The client device 7 displays an unregistered message “before using LAN, please register the device on the “Set LAN” menu of XXX (the name of the device) before using the LAN” shown in FIG. 6, so that the user is notified that the client device 7 is not registered and should be registered for access permission. Further, the method of registering a device may be displayed more specifically. The remote UI application acquisition request reception determining unit 16 may transmit an encrypted unregistered message display application. As a result, even if the name of the server device is a name of the device newly given after the client device is put on sale, the client device can display the name or the like of that new server device. Since the name of the menu of the server device can be described according to the name of the menu provided to the server, the menu name of the server device can be correctly displayed on any client devices.

According to the first embodiment, the client device of which access permission is desired to be registered is directly operated, the server device which receives the registration request for access permission for a certain period is selected, and the registration of the access permission is requested, so that the server device registers the access permission. As a result, the user need not be conscious of a MAC address, and thus even a person who does not have knowledge of networks can register the access permission for the client device easily and accurately. Further, since the counting unit 15 of the server device 2 receives the registration request for the access permission only for the certain period and does not receive the registration request for access permission for periods other than the certain period, the data of the server device can be protected against external devices.

According to the first embodiment, the client device receives the encryption remote UI application, and may decode (decipher) the received encryption remote UI application using a key owned only by an authorized client device. In this case, the data of the server device can be reproduced by using the decoded remote UI application. Therefore, even when an irregular client device receives the encryption remote UI application, since such a device does not have the decoding key, the device cannot properly decode the application. As a result, only the regular client device can access to and reproduce the data of the server device.

Further, when the server device is replaced by a new one, access permits for the client devices can be registered again into the new server device. As a result, a new encryption remote UI application is transmitted from the server device to the client device, and the remote UI application of the client device is rewritten to the new remote UI application. As a result, the new function can be used without renewing the client device.

### Second Embodiment

When a method of registering access permission according to an second embodiment is compared with the method of registering access permission according to the first embodiment, a difference from the first embodiment is that after the registration of the access permission is requested from a client apparatus to a server apparatus, the user moves from the client apparatus to the server apparatus and registers access permission for the client apparatus on the server apparatus side.

Since the constitutions of the server device 2 and the client device 6 in the method of registering access permission according to the second embodiment is substantially the same as the constitutions of the server device 2 and the client device 6 according to the first embodiment, the description thereof is not given.

### [Method of Registering Access Permission]

The method of registering access permission according to the second embodiment is described below.

In the case of the method of registering access permission according to the second embodiment, the client device 6 requests the registration of access permission, and the user moves from the client device 6 side to the server device 2 side so as to register access permission for the client device 6 on the server device 2 side.

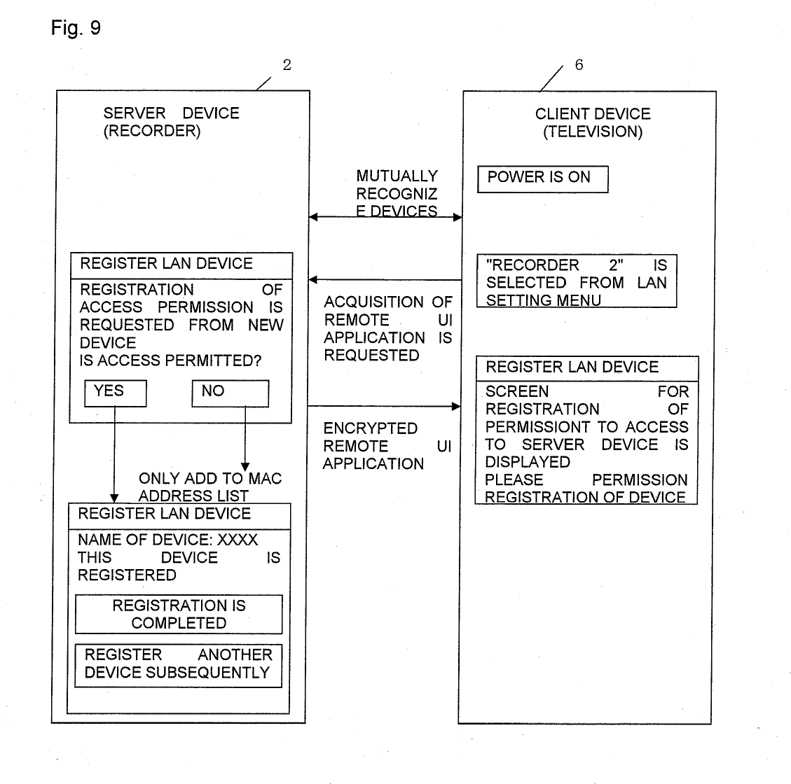

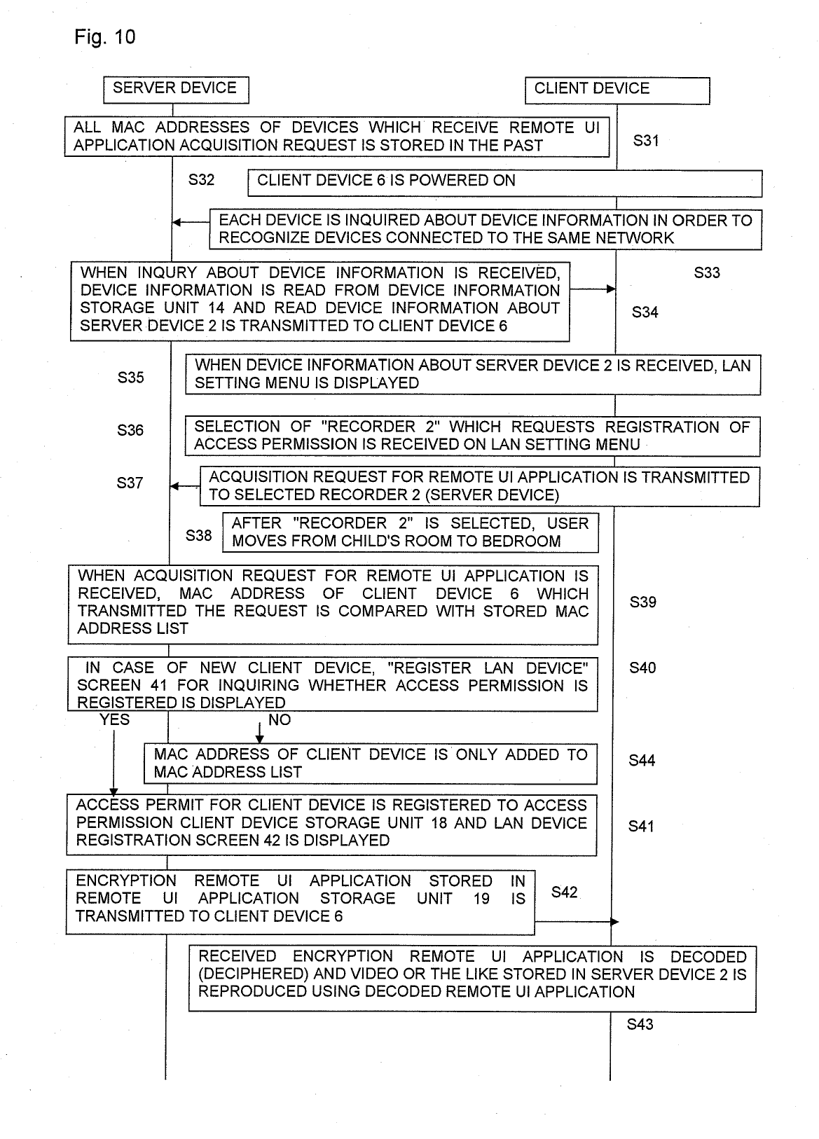

FIG. 9 illustrates screen transition in the case of the access permission registration from the menu screen of the client device 6 according to the second embodiment. Further, FIG. 10 illustrates a flowchart of the method of registering access permission according to the second embodiment.

(a) At first, the server device 2 stores all MAC addresses of the devices which receive the acquisition request for the remote UI application in the past (S31). A list of the stored MAC addresses is referred to as a MAC address list.

(b) The client device 6 is powered on (S32). When the client device 6 is powered on, the device recognizing unit 21 of the client device 6 inquires at each device about device information in order to recognize the devices connected to the same network (S33).

(c) When receiving the inquiry about the device information, the server device 2 reads the device information from the device information storage unit 14, and transmits the read device information about the server device 2 to the client device 6 (S34).

(d) When the client device 6 receives the device information about the server device 2, the client device 6 displays the LAN setting menu (S35).

(e) On the display screen of the client device 6, selection of “the recorder 2” for requesting for the registration of access permission on the LAN setting menu is received on the LAN setting menu (S36). As a result, the remote UI application acquiring unit 23 of the client device 6 transmits the acquisition request for the remote UI application to the selected recorder 2 (server device) (S37).

(f) As shown in FIG. 1, since the recorder (server device) 2 is in the bedroom and the television (client device) 6 is in the child's room, the user selects the “recorder 2” in the client device 6, and then moves from the child's room to the bedroom in contrast to the first embodiment (S38).

(g) When the remote UI application acquisition request reception determining unit 16 of the server device 2 receives the acquisition request for the remote UI application, the unit 16 compares the transmitted MAC address of the client device 6 with the MAC addresses list stored therein (S39).

(h) In a case of a new client device having a MAC address not described in the MAC address list, a screen 41 showing “Register LAN device” for inquiring about whether to register access permission for that client device is displayed (S40).

(i-1) When a “Yes” button is pressed down on the LAN device registration screen 41, the access permission registering unit 17 registers the access permission for the client device into the access permission client device storage unit 18, and displays a LAN device registration screen 42 (S41).

(j) Further, when the “Yes” button is pressed down in (i), the access permission registering unit 17 of the server device 2 transmits the encryption remote UI application stored in the remote UI application storage unit 19 to the client device 6 (S42).

(k) The client device 6 decodes (deciphers) the received encryption remote UI application, and reproduces a video or the like stored in the server device 2 by using the decoded remote UI application (S43).

(i-2) On the other hand, when a “No” button is pressed down on the LAN device registration screen 41, the MAC address of that client device is only added to the MAC address list (S44).

Through the above procedure, the access permission for the client device 6 can be registered.

The MAC address is one example of the device identification ID. The MAC address list is one example of the device identification ID list.

The method of registering access permission according to the present invention has an effect such that even a person who does not have knowledge of networks can easily register access permission for a client device, and is useful as a method of registering access permission into a server device to be used at general homes.

What is claimed is:

1. A method of registering access permission from a client apparatus into a server apparatus connected to one network, comprising:
notifying device information about the server apparatus to the client apparatus connected to the same network;
starting reception of a registration request for access permission from the client apparatus to the server apparatus;
counting a certain period starting from a point in time at which the reception of the registration request for access permission is started;
determining whether the server apparatus which receives the registration request for access permission is selected from the client apparatus and the registration request for the access permission of the access to the selected server apparatus is received within the certain period; and
registering the access permission for the client apparatus requesting for the registration of access permission into the server apparatus, when the registration request for access permission is received within the certain period.

2. The method of registering access permission according to claim 1, further comprising:
determining whether the server apparatus acquires an IP address in the network; and
displaying a screen for prompting start of the reception of the registration request for access permission from the client apparatus to the server apparatus on a screen of the server apparatus, when the server apparatus acquires the IP address in the network.

3. The method of registering access permission according to claim 1, further comprising:
identifying that the client apparatus is connected to the same network as the server apparatus; and
displaying a screen for prompting the start of the reception of the registration request for access permission from the client apparatus to the server apparatus on a screen of the server apparatus, when it is identified that the client apparatus is connected to the same network.

4. The method of registering access permission according to claim 2, wherein at the step of determining whether the IP address is acquired, determination is made whether the server apparatus acquires the IP address by polling, and the polling is stopped upon execution of the prompting display step.

5. The method of registering access permission according to claim 3, wherein at the step of identifying that the client apparatus is connected to the same network as the server network, determination is made whether the server apparatus recognizes the client apparatus by polling, and the polling is stopped upon execution of the prompting display step.

6. The method of registering access permission according to claim 1, further comprising:
transmitting, to the client apparatus, information for informing the client apparatus which requests the registration that the client network is unregistered and the registration of permission to access to the server apparatus is required, when the registration request is received after the certain period elapses.

7. A server apparatus which registers access permission from a client apparatus to the server apparatus connected to one network, comprising:
a device information storage unit operable to notify device information about the server apparatus to the client apparatus connected to the same network;
a counting unit operable to count a certain period starting from a point in time at which reception of a registration request for access permission is started;
a reception determining unit operable to determine whether the server apparatus is selected by the client apparatus and the registration request for access permission from the client apparatus to the server apparatus is received; and
an access permission registering unit operable to register access permission for the client apparatus which requests the registration of access permission to access to the server apparatus, when the registration request for access permission is received within the certain period.

8. The server apparatus according to claim 7, further comprising:
an IP address acquisition determining unit operable to determine whether the server apparatus acquires an IP address; and
a display unit operable to display a screen for prompting the registration request for the permission to access to the server apparatus on a display screen of the server apparatus, when the server apparatus acquires the IP address.

9. The server apparatus according to claim 7, further comprising:
a client determining unit operable to determine whether the client apparatus is connected to the same network as the server apparatus; and
a display unit operable to display a screen for prompting start of the reception of the registration request for the permission to access to the server apparatus from the client apparatus on a display screen of the server apparatus, when the identification is made that the client apparatus is connected to the same network.

10. The server apparatus according to claim 8, wherein the IP address acquisition determining unit determines whether the server apparatus acquires the IP address by polling, and stops the polling upon registration of access permission for the client apparatus in the access permission registering unit.

11. The server apparatus according to claim 9, wherein the client determining unit determines whether the client apparatus is recognized by polling, and stops the polling upon registration of the access permission for the client apparatus in the access permission registering unit.

12. The server apparatus according to claim 7, wherein the access permission registering unit further determines whether a code preset by the client apparatus is received, and registers the access permission for the client device only when the preset code is received.

13. A client apparatus which requests registration of permission to access to a server apparatus from the client apparatus connected to one network, comprising:
a device recognizing unit operable to receive notification of device information about the server apparatus from the server apparatus connected to the same network; and
an access permission registration requesting unit operable to select the server apparatus and requests registration of the permission to access to the server apparatus.

14. A server apparatus which registers permission to access to the server apparatus from a client apparatus connected to one network, comprising:
a device information storage unit operable to notify device information about the server apparatus to the client apparatus connected to the same network;
a reception determining unit operable to compare a device identification ID of the client apparatus transmitting the registration request for access permission with a stored device identification ID list, and when the client apparatus is a new client device having a device identification ID not described in the device identification ID list, receives determination whether the access permission for the client apparatus is registered, when the server apparatus is selected from the client apparatus and a request for the permission to access to the server apparatus is received from the client apparatus; and
an access permission registering unit operable to register the permission for the client apparatus to access to the server apparatus, when the determination of the access permission is received.

15. A method of registering access permission from a client apparatus to a server apparatus connected to one network, comprising:
notifying device information about the server apparatus to the client apparatus connected to the same network from a server apparatus side;
comparing a device identification ID of the client apparatus transmitting the registration request for access permission with a stored device identification ID list, when the server apparatus is selected from the client apparatus and a registration request for permission to access to the server apparatus from the client apparatus is received;
receiving determination whether the registration of the access permission for the client device is registered, when the client apparatus is a new client device having a device identification ID not described in the device identification ID list; and
registering the permission for the client apparatus to access to the server apparatus, when the determination of the access permission is received.
